(19) United States
(12) Patent Application Publication
(10) Pub. No.: US 2015/0235324 A1
(43) Pub. Date: Aug. 20, 2015

(54) DETECTING SUSPICIOUS ACTIVITY RELATED TO BALANCING TRANSACTIONS AT A CASH DRAWER

(71) Applicant: BANK OF AMERICA CORPORATION, Charlotte, NC (US)

(72) Inventors: Tami J. Rohrer, Charlotte, NC (US); Benjamin Henry Hoersch, Gastonia, NC (US); Kolt A. Bell, Charlotte, NC (US); Kshamata Goel, Mumbai (IN); James Kevin Harris, Charlotte, NC (US)

(73) Assignee: BANK OF AMERICA CORPORATION, Charlotte, NC (US)

(21) Appl. No.: 14/182,107

(22) Filed: Feb. 17, 2014

(51) Int. Cl. G06Q 40/00

(52) U.S. Cl. CPC G06Q 40/12

(57) ABSTRACT

Systems, apparatus, methods, and computer program products are provided for automatically monitoring cash balancing transactions conducted by individuals responsible for a cash drawer to determine unique behaviors/patterns of such individuals that are abnormal to the overall population of cash drawer users. Such proactive monitoring of cash balancing transactions provides for suspicious activity to be identified at the onset of such activity. As such, the identified suspicious activity can be further investigated to determine the cause of the activity. Thus, by identifying the suspicious activity at an earlier stage, financial losses to the financial institution can be reduced and reputational risk can be minimized.

### FIELD

In general, embodiments of the invention relate to mitigating risk associated with entrusting users with responsibility for a cash drawer and, more particularly, to detecting suspicious activity (e.g., force balancing) related to the balancing transaction that are conducted by cash drawer users.

### BACKGROUND

Financial institutions, specifically banking centers, consistently are plagued with problems related cash shortages (i.e., an incident in which the physical amount of cash on hand differs from the book recorded amount of cash). Such cash shortages can be attributed to many different actions, such as bank associate error, force balancing (i.e., inaccurate altering of the amount on the general ledger so that the amount matches the recorded amount), non-adherence to financial institution policy, banking associate malfeasance and the like.

In large enterprise-wide financial institutions, such cash shortages lead to further investigation to determine the cause(s) associated with the cash shortage. Such cash shortage-related internal investigations tend to be the most predominate in volume of all wrongful investigations conducted by financial institutions and result in a significant net loss for financial institutions.

However, the current approach taken by financial institutions to identify when a cash shortage or series of cash shortages should be escalated to the investigation level is generally reactionary and, as such, significant risk and/or financial loss may have already occurred prior to the cash shortage(s) being elevated to the investigation level.

Therefore, a need exists to develop a formalized and systematic approach to monitoring the balancing transactions (i.e., a counting of a cash drawer by an individual entrusted with the cash drawer) occurring with a financial institution. Such monitoring should identify differences (i.e., unique behavior/patterns) in the overall population of cash drawer users and, such identified differences may be deemed “suspicious activity” that warrant at least some level of investigation to determine if possible defalcation or forced balancing has occurred. By proactively identifying suspicious activity at an early stage than would be afforded by current processes, the desired invention should minimize loss exposure experienced by the financial institution.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, methods, computer program products or the like for automatically monitoring cash balancing transactions conducted by individuals responsible for a cash drawer to determine unique behaviors/patterns of such individuals that are abnormal to the overall population of cash drawer users. Such proactive monitoring of cash balancing transactions provides for suspicious activity to be identified at an earlier stage than conventional processing. As such, the identified suspicious activity can be further investigated to determine the cause of the activity. Thus, by identifying the suspicious activity at an earlier stage, financial losses to the financial institution can be reduced and reputational risk can be minimized.

An apparatus for determining suspicious activity related to balancing transactions at a cash drawer, defines first embodiments of the invention. The apparatus includes a computing platform including a memory and a processor in communication with the memory. The apparatus further includes a balancing transaction assessment module that is stored in the memory and executable by the processor. The balancing transaction assessment module is configured to receive balancing transaction data associated with a plurality of cash drawer balancing transactions conducted by a plurality of cash drawer users over a predetermined period of time, and, based on the balancing transaction data, determine that one or more of the cash drawer users has suspicious activity related to the balancing transactions conducted by the corresponding cash drawer user.

In specific embodiments of the apparatus, the balancing transaction assessment module is further configured to determine that the one or more of the cash drawer has suspicious activity based on identifying a pattern of suspicious activity over the predetermined period of time. In such embodiments of the apparatus, the pattern of suspicious activity may be determined based on determining that a predetermined number of cash difference values occurred over a predetermined number of time periods. A cash difference value is a difference between a total cash drawer amount counted by a cash drawer user and a total cash drawer amount indicated by a cash drawer accounting system (i.e., a book recorded amount). In a specific embodiments of the apparatus, the pattern of suspicious activity is based on determining that at least three cash difference values occurred per business day for at least two days within a five business day period (e.g., a business calendar week). In further specific embodiments of the apparatus, the balancing transaction assessment module is configured to rank the pattern of suspicious activity based on a number of cash difference values occurring per business day and a number of days within a calendar week in which the number of cash difference values occurred.

In other specific embodiments of the apparatus, the balancing transaction assessment module is configured to rank the suspicious activity according to predetermined levels of risk. In such embodiments of the apparatus, investigation priority for the suspicious activity may be assigned based the level of risk associated with the suspicious activity.

In still further specific embodiments of the apparatus, the balancing transaction assessment module is further configured to receive the balancing transaction data including, for each balancing transaction conducted by the cash drawer user, (1) a time and date of the balancing transaction, (2) a total cash drawer amount counted by the cash drawer user, (3) a total cash drawer amount indicated by a cash drawer accounting system, and (4) a cash difference value that is a difference between the total cash drawer amount counted and the total cash drawer amount indicated by the cash drawer accounting system.

A method for determining suspicious activity related to balancing transactions at a cash drawer, defines second embodiments of the invention. The method includes receiving, by a computing device, balancing transaction data associated with a plurality of cash drawer balancing transactions conducted by a plurality of cash drawer users over a predetermined period of time, and, in response to receiving the balancing transaction data, determining, by a computing device processor, that one or more of the cash drawer users has suspicious activity related to the balancing transactions conducted by the corresponding cash drawer user.

In specific embodiments of the method, determining that the one or more of the cash drawer has suspicious activity further comprises identifying, by a computing device, a pattern of suspicious activity over the predetermined period of time. In further specific embodiments of the method, identifying the pattern of suspicious activity further includes determining, by a computing device processor, that a predetermined number of cash difference values occurred over a predetermined number of time periods. A cash difference value is a difference between a total cash drawer amount counted by a cash drawer user and a total cash drawer amount indicated by a cash drawer accounting system (i.e., a book recorded amount). In one specific embodiments of the method, identifying the pattern of suspicious activity further includes determining, by a computing device processor, that at least three cash difference values occurred per business day for at least two days within a five day period (e.g., a business week). In still further specific embodiment the method includes ranking, by a computing device processor, the pattern of suspicious activity based on a number of cash difference values occurring per business day and a number of days within a five day period in which the number of cash difference values occurred.

In still further specific embodiments of the method includes ranking, by a computing device processor, the suspicious activity according to predetermined levels of risk. In such embodiments the ranking is used to determine the investigation priority to assign to the suspicious activity.

In yet other embodiments of the method, receiving balancing transaction data further comprises receiving, by the computing device, the balancing transaction data that includes, for each balancing transaction conducted by the cash drawer user, (1) a time and date of the balancing transaction, (2) a total cash drawer amount counted by the cash drawer user, (3) a total cash drawer amount indicated by a cash drawer accounting system, and (4) a cash difference value that is a difference between the total cash drawer amount counted and the total cash drawer amount indicated by the cash drawer accounting system.

A computer program product including a non-transitory computer-readable medium defines third embodiments of the invention. The computer-readable medium includes a first set of codes for causing a computer to receive balancing transaction data associated with a plurality of cash drawer balancing transactions conducted by a plurality of cash drawer users over a predetermined period of time. The computer-readable medium additionally includes a second set of codes for causing a computer to determine, based on the balancing transaction data, that one or more of the cash drawer users has suspicious activity related to the balancing transactions conducted by the one or more cash drawer users.

Thus, systems, apparatus, methods, and computer program products herein described in detail below provide for automatically determining suspicious activity related to cash balancing transactions conducted by cash drawer users. Cash balancing transaction data is received, via a production feed or the like, that allows for suspicious activity to be determined based on identifying patterns of abnormal behavior in the balancing transaction data. Once suspicious activity has been determined further investigation can incur to determine if the activity is related to force balancing, misappropriation or some other risk related activity. As such the present invention provides for proactive early detection of suspicious activities associated with cash balancing and, as a result, reduces the risk of financial loss imposed on cash drawer owner.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for determining suspicious activity related to cash balancing transactions conducted by a cash drawer user, in accordance with embodiments of the present invention;

FIG. 2 provides a more detailed block diagram of an apparatus configured for determining suspicious activity related to cash balancing transactions conducted by a cash drawer user , in accordance with present embodiments of the invention;

FIG. 3 provides a table that indicates different levels of risk based on the number of times periods in which a predetermined number of cash difference values occur during a time period, in accordance with present embodiments of the invention;

FIG. 4 provides a flow diagram of a method for determining suspicious activity related to cash balancing transactions conducted by a cash drawer user, in accordance with present embodiments of the invention; and

FIG. 5 provides a flow diagram of a method for determining suspicious activity related to cash balancing transactions conducted by a cash drawer user and investigating the suspicious activity, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for automatically monitoring cash balancing transactions conducted by individuals entrusted with a cash drawer (i.e., cash drawer user) to determine unique behaviors/patterns of such individuals that are abnormal to the overall population of cash drawer users. Cash balancing, as used herein, is defined as an amount of cash in the cash drawer as physically counted by the cash drawer user in comparison to the current book recorded/accounting system amount (i.e., the amount the cash drawer should currently hold). Such proactive monitoring of cash balancing transactions provides for suspicious activity to be identified at an earlier stage than conventional methodology. As such, the identified suspicious activity can be further investigated to determine the cause of the activity. In certain instances the cause of the suspicious activity may uncover unauthorized or illegal activity by the cash drawer owner, such as force balancing, misappropriation of funds or the like. Thus, by identifying the suspicious activity at an earlier stage, financial losses to the financial institution can be reduced and reputational risk can be minimized.

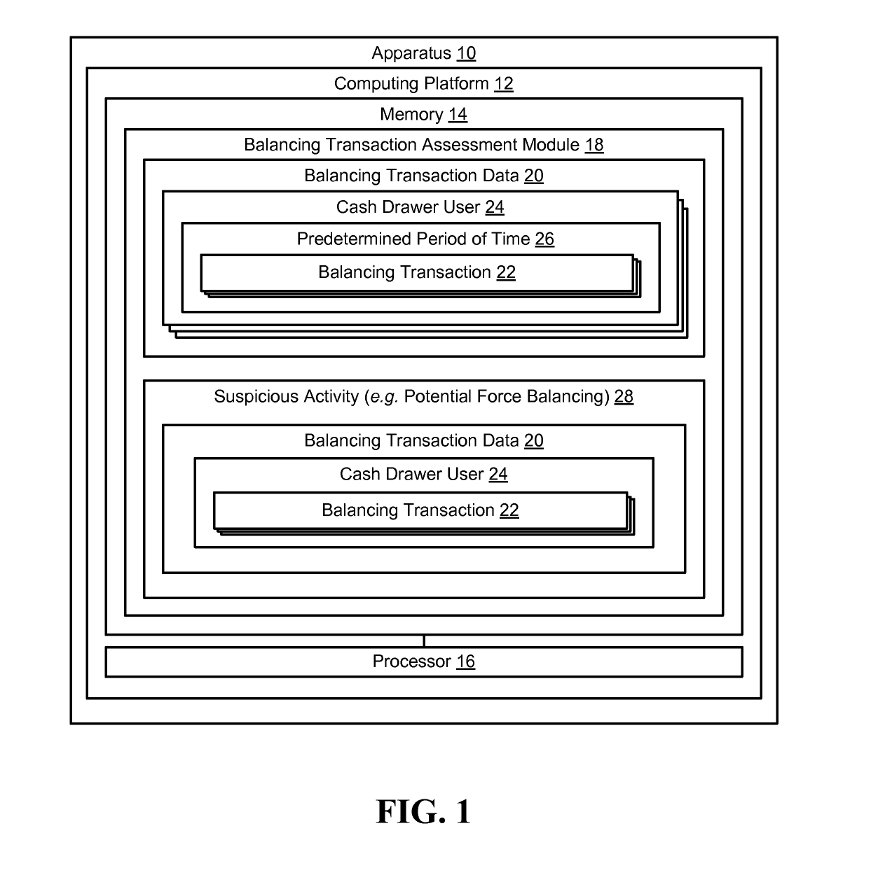

Referring to FIG. 1, a block diagram is presented of an apparatus 10 configured determining suspicious activity related to cash balancing transactions conducted by an individual entrusted with a cash drawer. The apparatus includes a computing platform 12 having a memory 14 and at least one processor 16 in communication with the memory 14. The memory 14 of apparatus 10 stores balancing transaction assessment module 18 that is configured to determine suspicious activity resulting from the cash balancing activities conducted by a plurality of individuals (referred to herein as cash drawer users), each entrusted with a corresponding cash drawer. While embodiments of the invention herein described are most applicable for implementation within a large enterprise-wide financial institution, such as a bank, in other embodiments other entities, such as large retailers or the like may implement the embodiments herein described to determine suspicious activity associated with cash balancing transactions at a cash drawer (e.g., cash register).

The balancing transaction assessment module 14 is configured to receive balancing transaction data 20 associated with a plurality of cash drawer balancing transactions 22 conducted by cash drawer users 24 over a predetermined period of time 26. For example, the module 14 may be configured to receive “live” real-time feeds of balancing transaction data 20 as cash balancing transactions 22 occur or the module 14 may be configured to receive feeds of balancing transaction data 20 on a regularly scheduled basis, such as at the end of a business day or the like or on an as-needed basis. The predetermined period of time 26 over which the data 20 is received will be configured by the module user (e.g., the bank, the retailer or the like) so as to allow for patterns to be identified in the balancing transaction data 20. In one specific embodiment of the invention, the predetermined period of time 26 may be five consecutive business days or a business week (e.g., Monday-Friday).

The business transaction assessment module 14 is further configured to implement the balancing transaction data 20 to determine that one or more cash drawer users 24 has suspicious activity 28 related to the balancing transactions 22 conducted by the corresponding cash drawer user 24. In specific embodiments of the invention, the determination of suspicious activity 28 may result in further investigation by the bank, retailer or the like to determine if the nature of the suspicious activity 28 and, if the suspicious activity 28 requires further action on behalf of the bank, retailer or the like. For example, if the suspicious activity 28 results in an investigator determining that a cash drawer user 24 has been force balancing (i.e., inaccurate altering of the amount on the general ledger so that the amount matches the recorded amount), or misappropriating funds the cash drawer user may be reprimanded, dismissed or the like. In another example, if the suspicious activity 28 results in an investigator determining that a cash drawer user 24 is negligent in performing cash balancing transactions the cash drawer user may be re-trained, reprimanded, dismissed or the like.

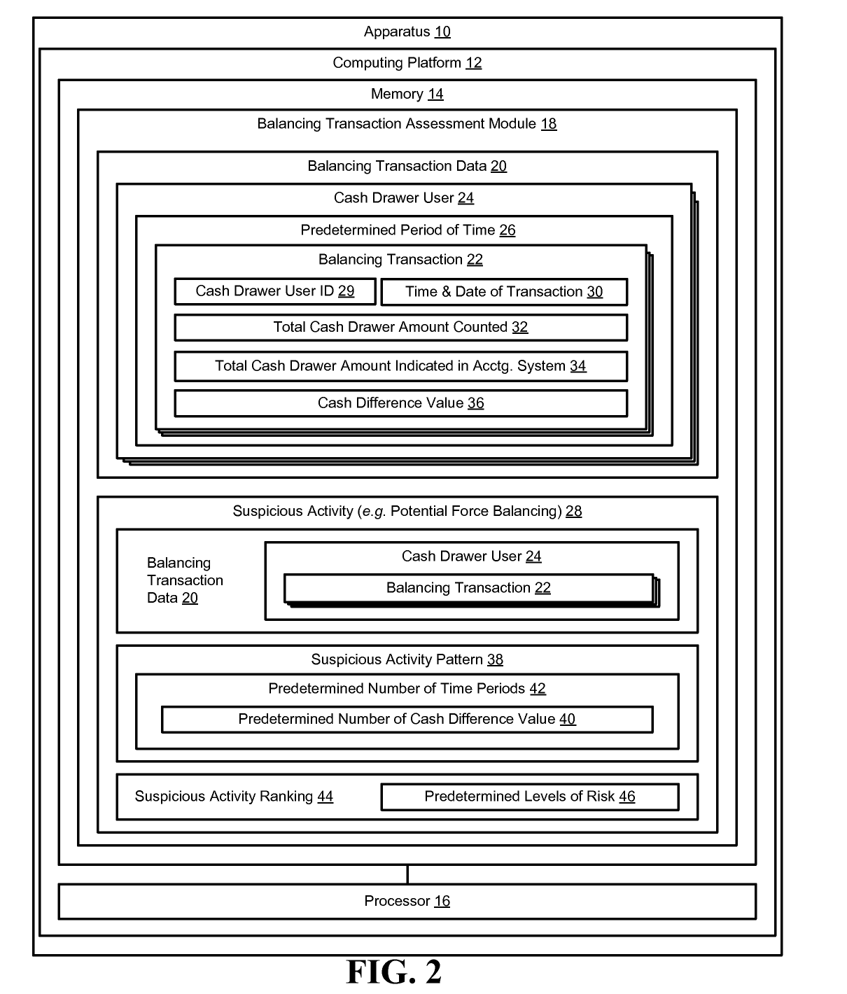

Referring to FIG. 2, a block diagram is presented of an apparatus 10 configured to determine suspicious activity related to cash balancing transactions conducted by an individual entrusted with a cash drawer, in accordance with embodiments of the present invention. The apparatus 10 may include any type and/or combination of one or more computing devices. The apparatus 10 is operable to receive and execute modules, routines and applications, such as balancing transaction assessment module 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 2) that interfaces with any resident programs, such as balancing transaction assessment module 18 or the like, stored in the memory 14 of apparatus 10. Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of balancing transaction assessment module 18 obviating the need for such applications and modules to be stored in the memory.

As previously noted in relation to FIG. 1, memory 14 stores balancing transaction assessment module 18 that is configured to determine suspicious activity resulting from the cash balancing activities conducted by a plurality of cash drawer users, each entrusted with a corresponding cash drawer. The balancing transaction assessment module 14 is configured to receive balancing transaction data 20 associated with a plurality of cash drawer balancing transactions 22 conducted by cash drawer users 24 over a predetermined period of time 26. The balancing transaction data 20 may include, but is not limited to, identification of the cash drawer user 29 conducting the balancing transaction, date and time of each balance transaction 30, the total cash drawer amount counted 32 for each transaction, the total cash drawer indicated in the record/accounting system 34 at the time of the balancing transaction and/or the cash difference value for each transaction 36 (i.e., the difference between the amount counted by the cash drawer user and the amount indicated by the record/accounting system). In further embodiments of the invention, the balancing transaction data 20 may include a transaction code, which indicates the type of balancing transaction and a breakdown of the paper and coin currencies in one or both of the amount counted and the amount indicated in the record/accounting system.

The business transaction assessment module 14 is further configured to implement the balancing transaction data 20 to determine that one or more cash drawer users 24 has suspicious activity 28 related to the balancing transactions 22 conducted by the corresponding cash drawer user 24. In specific embodiments of the invention, the module 14 is configured to determine that one or more cash drawer users 24 exhibits suspicious activity 28 based on identifying a suspicious activity pattern 38 over the predetermined period of time 26. In such embodiments of the invention, the suspicious activity pattern 38 may be identified based on the occurrence of a predetermined number of cash difference values 40 over a predetermined number of time periods 42 within the predetermined period of time 26. As previously noted, a cash difference value is a difference between the amount counted by the cash drawer user and the amount indicated by the record/accounting system at the time of the cash balance transaction. For example, in one specific example, a suspicious activity pattern 38 may be identified based on determining at least three cash difference values per business day for at least two days within a five day period.

It should be noted that the examples provided above for identifying patterns based on the occurrence of different cash difference values. Thus, for example, if a cash drawer user conducts five cash balancing transactions during a business day and the cash difference values are (1) $1,059.60 for the first cash balancing transaction; (2) $59.60 for the second cash balancing transaction; (3) $0.40 for the third cash balancing transaction; (4) $0.00 for the fourth cash balancing transaction; and (5) $0.40 for the fifth cash balancing transaction , the number of cash difference values for that particular day is four ($1,059.60, $59.60, $0.40 and $0.00). The occurrence of the $0.40 cash difference value in the fifth balancing transaction being the same as the cash difference value in the third balance transaction and, therefore, the second occurrence of $0.40 (or any subsequent occurrences of $0.40 or any of the other cash difference values that have occurred during that business day) does not warrant inclusion in the number of cash difference values for that business day.

It should also be noted that patterns may be identified based on factoring the time differences within the business day between cash balancing transactions. For example, in the example above, if the five cash balancing transactions occur one right after the other (e.g., at the end of a business day) more, or in some embodiments less, weight may be placed on such cash balancing transactions in determining suspicious activity. Conversely, if the five cash transactions occur sporadically throughout the business day less, or in some embodiments more, weight may be placed on such cash balancing transactions in determining suspicious activity.

Moreover, while the embodiment described above only takes into account the number of cash difference values that occur, other embodiments of the invention may take into account the actual cash difference amounts in identifying a pattern and/or determining suspicious activity. For example, if a cash drawer user conducts five cash balancing transactions during a business day and the cash difference values are (1) $4,083.50 for the first cash balancing transaction; (2) $64.60 for the second cash balancing transaction; (3) $3,077.04 for the third cash balancing transaction; (4) $0.27 for the fourth cash balancing transaction; and (5) $0.00 for the fifth cash balancing transaction, five cash difference values have occurred with a wide variance in the cash difference amounts and, such wide variance in amounts may be weighted more in identifying patterns and/or determining suspicious activity. However, if a cash drawer user conducts five cash balancing transactions during a business day and the cash difference values are (1) $0.50 for the first cash balancing transaction; (2) $0.60 for the second cash balancing transaction; (3) $0.53 for the third cash balancing transaction; (4) $0.72 for the fourth cash balancing transaction; and (5) $0.00 for the fifth cash balancing transaction, five cash difference values have occurred with a small variance in the cash difference amounts and, such small difference in amounts may be weighted less in identifying a pattern and/or determining suspicious activity.

In addition, while the embodiments described above identify patterns based on the number of occurrences of cash difference values, the module 14 may be configured to identify patterns and/or determine suspicious activity based on other criteria, for example, the number of occurrences of a change in a cash difference value. For example, if a cash drawer user conducts five cash balancing transactions during a business day and the cash difference values are (1) $59.60 for the first cash balancing transaction; (2) $59.60 for the second cash balancing transaction; (3) $0.00 for the third cash balancing transaction; (4) $0.00 for the fourth cash balancing transaction; and (5) $0.25 for the fifth cash balancing transaction, two occurrences of a change in cash difference value have occurred (i.e., (1) $59.60 to $0.00 and (2) $0.00 to $0.25). Conversely, if the cash drawer user conducts five cash balancing transactions during a business day and the cash difference values are (1) $1,000.00 for the first cash balancing transaction; (2) $0.00 for the second cash balancing transaction; (3) $1,000.00 for the third cash balancing transaction; (4) $0.00 for the fourth cash balancing transaction; and (5) $1,000.00 for the fifth cash balancing transaction, four occurrences of a change in cash difference value have occurred (i.e., (1) $1,000.00 to $0.00, (2) $0.00 to $1,000.00, (3) $1,000.00 to $0.00 and (4) $0.00 to $1,000) (while only two cash difference vales have occurred—(1) $1,000.00 and (2) $0.00).

In addition, to determining suspicious activity 28, the balancing transaction assessment module 18 may also be configured to provide for a suspicious activity ranking 44 based on predetermined levels of risk 46. In specific embodiments the predetermined levels of risk 46 are based on the strength of the pattern identified. For example, in one specific embodiment of the invention three level of risk are defined, such that each level of risk is associated with pattern strength. In such embodiments of the invention, the level of risk 46 assigned to a suspicious activity and/or the suspicious activity ranking 44 may be used to determine which suspicious activities should be investigated and/or the order in which suspicious activities should be investigated.

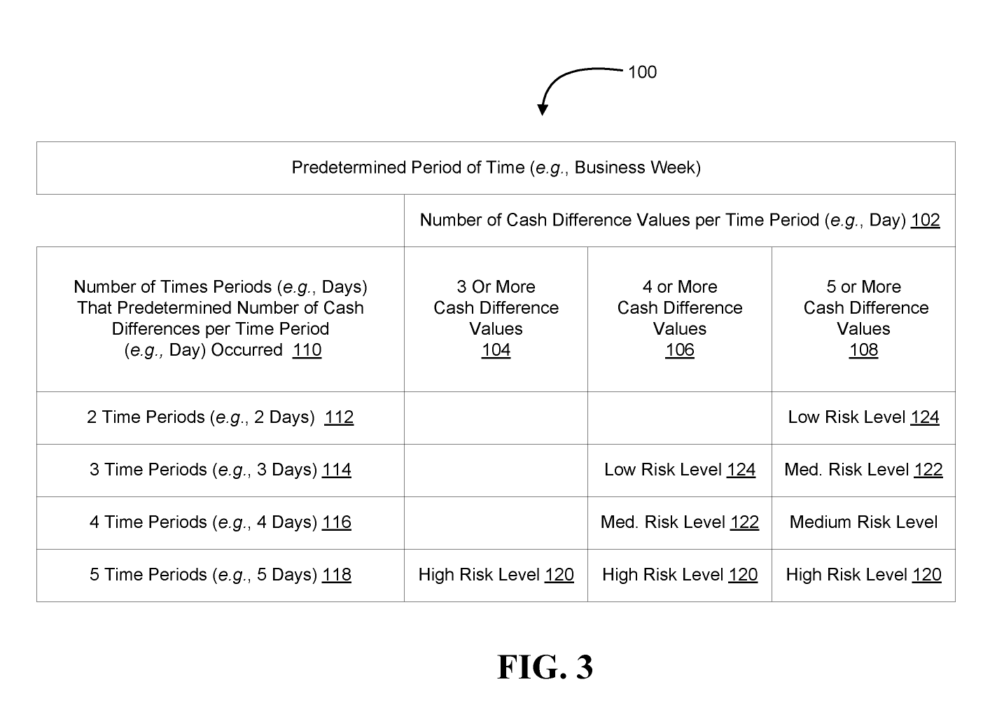

Referring to FIG. 3 a table is shown that indicates different levels of risk based on the number of times periods in which a predetermined number of cash difference values occur during a time period, in accordance with present embodiments of the invention. In the illustrated embodiments, suspicious activity is determined based on identifying a pattern, which is identified based on determining that a predetermined number of cash difference values occurred over a predetermined number of time periods. In the table 100 the columns 102 represent the number of cash difference values per time period (e.g., per business day), with the first column 104 indicating three or more cash difference values per time period, the second column 106 indicating four or more cash difference values per time period and the third column 108 indicating five or more cash difference values per time period. The rows 110 represents the number of time periods (e.g., days) that the predetermined number of cash differences per time period (e.g., day) occurred, with the first row 112 indicating two time periods (e.g., two days), the second row 114 indicating three time periods (e.g., three days) and the third row 116 indicating four time periods (e.g., four days) and the fourth row 118 indicating five time periods (e.g., five days). In accordance with one specific embodiment, as shown in FIG. 3, a high level of risk 120 is associated with a pattern defined by the occurrence of three or more cash difference values per business day occurring each of the five days within a five day period, a medium level of risk 122 is associated with a pattern defined by the occurrence of four or more cash difference values per business day occurring four days within a five day period or the occurrence of five or more cash difference values per business day occurring three days within a five day period, and a low level of risk 124 is associated with a pattern defined by four or more cash difference values per business day occurring three days within a five day period or five or more cash difference values per business day occurring two days within the five day period. As previously noted the levels of risk may be used to prioritize the order in which suspicious activity is investigated and/or the type of investigation that is conducted.

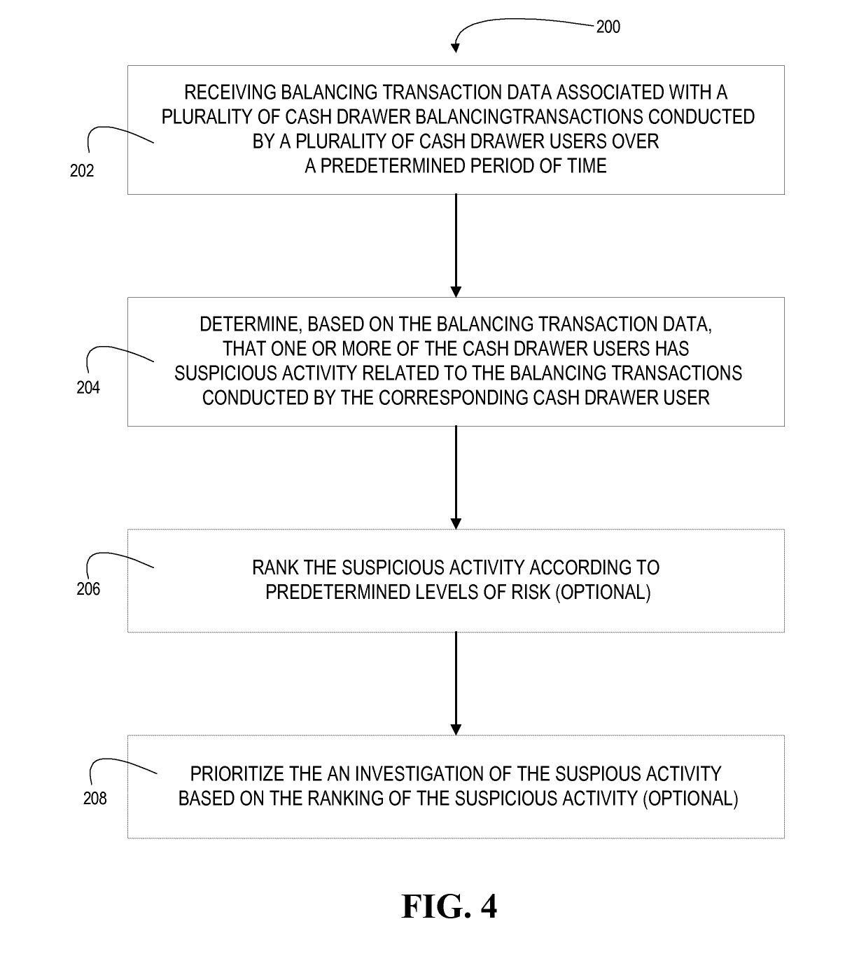

FIG. 4 is a flow diagram depicting a method 200 for determining suspicious activity related to balancing transactions at a cash drawer, in accordance with embodiments of the present invention. At Event 202, balancing transaction data is received. The balancing transaction data is associated with a plurality of cash drawer balancing transactions conducted by a plurality of cash drawer users over a predetermined period of time. For example, the cash drawer balancing transactions may be most, it not all, of the balancing transactions conducted within an enterprise financial institution or the like. The balancing transaction data may be received via a feed on an on-going basis, such as after every business day or the like. In addition, in specific embodiments of the method, the balancing transaction data may include, but is not limited to, a cash drawer user identification, a time and date of the balancing transaction, a total cash amount counted by the cash drawer user, a total cash drawer amount indicated by the record/accounting system at the time of the balancing transaction and/or a cash difference value that is the difference between the total cash drawer amount counted by the user and the total cash drawer amount indicated by the record/accounting system.

At Event 204, a determination is made, based on the balancing transaction data, that one or more of the cash drawer users has suspicious activity related to the balancing transactions conducted by the corresponding cash drawer user. In specific embodiments of the method, the suspicious activity is determined by identifying a pattern of suspicious activity events in the balancing transaction data. In such embodiments of the method, the pattern may be identified by determining that a predetermined number of cash difference values occurred over a predetermined number of time periods. For example, a pattern may be identified based on at least three cash difference values occurring per business day for at least two days within a five day period (e.g., a business week). In alternate embodiments other criteria may be used in addition to or in lieu of the number of cash difference values, such as the proximity in time of the balancing transactions, the amounts of the cash difference values, the similarity of the amounts of the cash difference values or the like.

At optional Event 206, the suspicious activity may be ranked according to predetermined levels of risk. In one specific embodiment of the method, the pattern of suspicious activity may be ranked based on the number of cash difference values occurring per business day and the number of days within a five day period in which the number of cash difference values occurred. For example, a highest level of risk may be associated with a pattern defined by the occurrence of three or more cash difference values per business day occurring each of the five days within a five day period, a medium level of risk may be associated with a pattern defined by the occurrence of four or more cash difference values per business day occurring four days within a five day period or the occurrence of five or more cash difference values per business day occurring three days within a five day period, and a lowest level of risk may be associated with a pattern defined by four or more cash difference values per business day occurring three days within a five day period or five or more cash difference values per business day occurring two days within the five day period.

At optional Event 208, an investigation of the suspicious activity is prioritized based on the ranking of suspicious activity. For example, cash drawer users having suspicious activity that falls into the highest level of risk may be assigned a highest priority for investigation, such that those cash drawer users are investigated first, prior to the investigation of other medium level risk or low level risk suspicious activity.

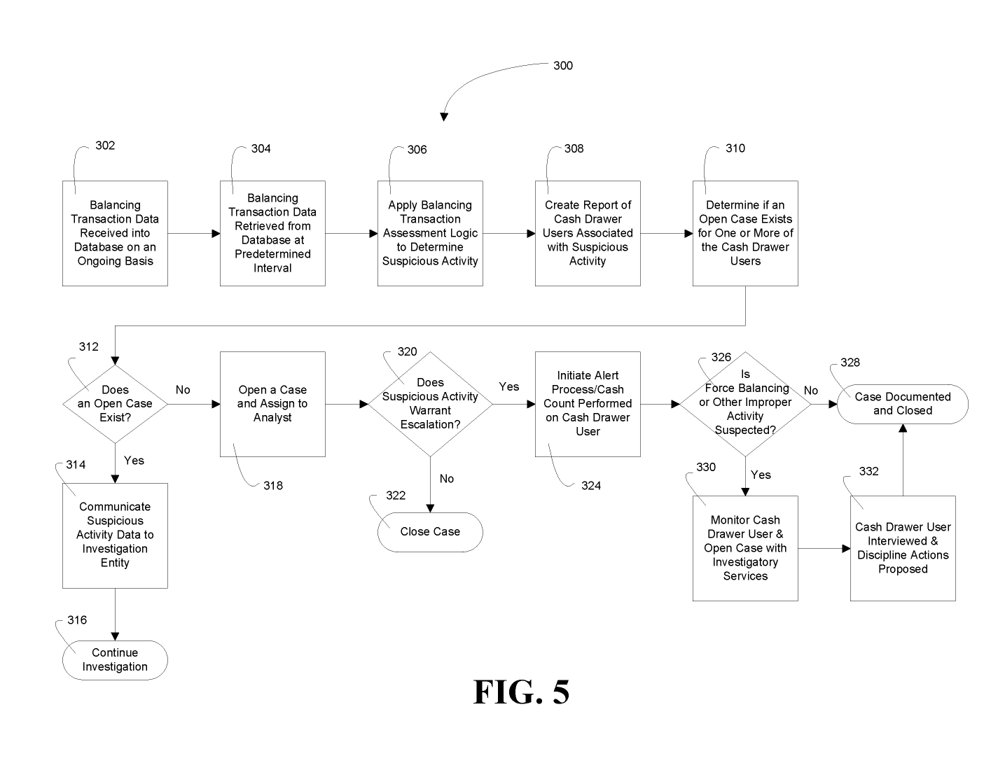

FIG. 5 is a flow diagram of a method 300 determining suspicious activity related to cash balancing transactions conducted by a cash drawer user and investigating the suspicious activity, in accordance with embodiments of the present invention. At Event 302, balancing transaction data is received into a database on an ongoing basis. Typically, data feeds will be accumulated over a business day and subsequently stored in the database. At Event 304, balancing transaction is retrieved from the database at a predetermined interval. The predetermined interval will coincide with the predetermined period of time over which suspicious activity is to be determined (e.g., suspicious activity patterns identified). For example, in specific embodiments the balancing transaction data is retrieved from the database on a weekly basis.

At Event 306, the balancing transaction assessment logic is applied to the balancing transaction data to determine suspicious activity. As previously noted, the logic may be configured to identify patterns in the balancing transaction data that are inconsistent with patterns normally experienced by the population of cash drawer users. In specific embodiments the logic may be configured to identify patterns by determining that a predetermined number of cash difference values have occurred over a predetermined number of time periods (e.g., days) within the period of time (e.g., a business week). Once suspicious activity has been determined, at Event 308 a report is generated that includes the cash drawer users that have been determined to be associated with suspicious activity.

At Event 310 and Decision 312 a determination is made as to whether an open case exists for one or more of the cash drawer users that have been determined to be associated with suspicious activity. An “open case” means that the cash drawer user is currently being investigated and the investigation may be based on a previous determination of suspicious activity (i.e., suspicious activity for a prior business week or the like). If a determination is made that an open case does exist, at Event 314, the suspicious activity data that has currently been determined is communicated to the investigation entity and, at Event 316, the investigation continues.

If a determination is made that that an open case does not currently exist, at Event 318, a case is opened and a pre-investigation analyst is assigned to the case. At Decision 320, a determination is made as to whether the suspicious activity warrants escalation. In certain instances, minimal investigation may determine that the suspicious activity is not associated with an intentional improper and/or illicit behavior on behalf of the cash drawer user (e.g., negligent and inconsequential cash drawer counting or the like). If the suspicious activity is determined to not warrant escalation, at Event 322, the case is closed and no further action is taken.

If a determination is made that the case should be escalated, at Event 324, an alert is generated and communicated which requests that one or more cash counts be performed on the cash drawer user. A cash count is a counting of the cash drawer by someone other than the cash drawer user (e.g., a supervisor) and is implemented to identify intentional improper behavior on behalf of the cash drawer user.

At Decision 326, a determination is made as to whether force balancing or another improper activity/behavior is suspected as being conducted by the cash drawer user. Force balancing is inaccurate altering of the amount on the general ledger so that the amount matches the recorded amount. If force balancing or another improper behavior is not suspected, at Event 328, the case is documented and the case is closed with no further action is taken. If force balancing is suspected, at Event 330, the cash drawer user is monitored (e.g., cash balancing transactions monitored and/or more frequent cash counts) and a case is opened with investigatory services. At Event 330, as a result of the investigation, the cash drawer user is interviewed for the purpose of confirming the improper behavior and possible disciplinary actions are proposed.

Thus, systems, apparatus, methods, and computer program products described above provide for automatically determining suspicious activity related to cash balancing transactions conducted by cash drawer users. Cash balancing transaction data is received, via a production feed or the like, that allows for suspicious activity to be determined based on identifying patterns of abnormal behavior in the balancing transaction data. Once suspicious activity has been determined further investigation can incur to determine if the activity is related to force balancing, misappropriation or some other risk related activity. As such the present invention provides for proactive early detection of suspicious activities associated with cash balancing and, as a result, reduces the risk of financial loss imposed on a cash drawer owner, such as a bank, retailer or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for determining suspicious activity related to balancing transactions at a cash drawer, the apparatus comprising:
a computing platform including a memory and a processor in communication with the memory;
a balancing transaction assessment module stored in the memory, executable by the processor and configured to,
receive, into a database, ongoing data feeds of balancing transaction data associated with a plurality of cash drawer balancing transactions conducted by a plurality of cash drawer users over a predetermined period of time,
accessing the database at predetermined intervals to retrieve the balancing transaction data, and
based on the balancing transaction data, determine that one or more of the cash drawer users has suspicious activity related to the balancing transactions conducted by the corresponding cash drawer user based on identifying, from the balancing transaction data, a pattern of suspicious activity over the predetermined period of time, wherein identifying the pattern comprises determining that a predetermined number of different cash difference values occurred over a predetermined number of time periods, wherein a cash difference value is a difference between a total cash drawer amount counted by a cash drawer user and a total cash drawer amount indicated by a cash drawer accounting system.

2. (canceled)

3. (canceled)

4. The apparatus of claim 1, wherein the balancing transaction assessment module is further configured to identify the pattern of suspicious activity over the predetermined period of time based on determining that at least three cash difference values occurred per business day for at least two days within a five day period.

5. The apparatus of claim 1, wherein the balancing transaction assessment module is further configured to rank the pattern of suspicious activity based on a number of cash difference values occurring per business day and a number of days within a five day period in which the number of cash difference values occurred.

6. The apparatus of claim 1, wherein the balancing transaction assessment module is further configured to rank the suspicious activity according to predetermined levels of risk.

7. The apparatus of claim 1, wherein the balancing transaction assessment module is further configured to receive balancing transaction data, wherein the balancing transaction data includes, for each balancing transaction conducted by the cash drawer user, (1) a time and date of the balancing transaction, (2 ) a total cash drawer amount counted by the cash drawer user, (3) a total cash drawer amount indicated by a cash drawer accounting system, and (4) a cash difference value that is a difference between the total cash drawer amount counted and the total cash drawer amount indicated by the cash drawer accounting system.

8. A method for determining suspicious activity related to balancing transactions at a cash drawer, the apparatus comprising:
receiving, at a computing device database, ongoing data feeds of balancing transaction data associated with a plurality of cash drawer balancing transactions conducted by a plurality of cash drawer users over a predetermined period of time, and
determining, by a computing device processor, based on the balancing transaction data, that one or more of the cash drawer users has suspicious activity related to the balancing transactions conducted by the corresponding cash drawer user based on identifying, from the balancing transaction data, a pattern of suspicious activity over the predetermined period of time, wherein identifying the pattern comprises determining that a predetermined number of different cash difference values occurred over a predetermined number of time periods, wherein a cash difference value is a difference between a total cash drawer amount counted by a cash drawer user and a total cash drawer amount indicated by a cash drawer accounting system.

9. (canceled)

10. (canceled)

11. The method of claim 8, wherein identifying the pattern of suspicious activity over the predetermined period of time further comprises determining, by a computing device processor, that at least three cash difference values occurred per business day for at least two days within a five day period.

12. The method of claim 8, further comprising ranking, by a computing device processor, the pattern of suspicious activity based on a number of cash difference values occurring per business day and a number of days within a five day period in which the number of cash difference values occurred.

13. The method of claim 8, further comprising ranking, by a computing device processor, the suspicious activity according to predetermined levels of risk.

14. The method of claim 8, wherein receiving balancing transaction data further comprises receiving, by the computing device, the balancing transaction data that includes, for each balancing transaction conducted by the cash drawer user, (1) a time and date of the balancing transaction, (2) a total cash drawer amount counted by the cash drawer user, (3) a total cash drawer amount indicated by a cash drawer accounting system, and (4) a cash difference value that is a difference between the total cash drawer amount counted and the total cash drawer amount indicated by the cash drawer accounting system.

15. A computer program product comprising:
a non-transitory computer-readable medium comprising:
a first set of codes for causing a computer to receive, into a database, ongoing data feeds of balancing transaction data associated with a plurality of cash drawer balancing transactions conducted by a plurality of cash drawer users over a predetermined period of time;
a second set of codes for causing a computer to access the database at predetermined intervals to retrieve the balancing transaction data and
a third set of codes for causing a computer to determine, based on the balancing transaction data, that one or more of the cash drawer users has suspicious activity related to the balancing transactions conducted by the one or more cash drawer users based on identifying, from the balancing transaction data, a pattern of suspicious activity over the predetermined period of time, wherein identifying the pattern comprises determining that a predetermined number of different cash difference values occurred over a predetermined number of time periods, wherein a cash difference value is a difference between a total cash drawer amount counted by a cash drawer user and a total cash drawer amount indicated by a cash drawer accounting system.

16. (canceled)

17. (canceled)

18. The computer program product of claim 15, wherein the second set of codes is further configured to cause the computer to identify the pattern of suspicious activity over the predetermined period of time based on determining that at least three cash difference values occurred per business day for at least two days within a five day period.

19. The computer program product of claim 15, further comprising a third set of codes configured to cause a computer to rank the pattern of suspicious activity based on a number of cash difference values occurring per business day and a number of days within a five day period in which the number of cash difference values occurred.

20. The computer program product of claim 15, further comprising a third set of codes for causing a computer to rank the suspicious activity according to predetermined levels of risk.

21. The computer program product of claim 15, wherein the first set of codes is further configured to cause the computer to receive the balancing transaction data, wherein the balancing transaction data includes, for each balancing transaction conducted by the cash drawer user, (1) a time and date of the balancing transaction, (2) a total cash drawer amount counted by the cash drawer user, (3) a total cash drawer amount indicated by a cash drawer accounting system, and (4) a cash difference value that is a difference between the total cash drawer amount counted and the total cash drawer amount indicated by the cash drawer accounting system.
